(19) United States
(12) Patent Application Publication
(10) Pub. No.: US 2022/0215987 A1
(43) Pub. Date: Jul. 7, 2022

(54) CABLE

(71) Applicants: FOXCONN (KUNSHAN) COMPUTER CONNECTOR CO., LTD., Kunshan (KY); FOXCONN INTERCONNECT TECHNOLOGY LIMITED, Grand Cayman (KY)

(72) Inventors: DUO CHEN, Kunshan (CN); JUAN ZHENG, Kunshan (CN); LU-YU CHANG, New Taipei (TW)

(21) Appl. No.: 17/561,922

(22) Filed: Dec. 25, 2021

(30) Foreign Application Priority Data
Jan. 4, 2021 (CN) 202110002751.7

(51) Int. Cl. H01B 11/20; H01B 11/00; H01B 11/10; H01B 7/17; H01B 11/18

(52) U.S. Cl. CPC H01B 11/203; H01B 11/002; H01B 11/1834; H01B 7/17; H01B 11/1091

(57) ABSTRACT

A cable includes: a pair of wires including two inner conductors and a respective insulating layer covering each of the two inner conductors; a first shielding layer covering the pair of wires; a second shielding layer covering the first shielding layer; and an outer coating layer covering the second shielding layer, wherein the insulation layer is covered with a sheath layer that is simultaneously extruded and formed, and the sheath layer covers the wires so that the two wires abut each other in parallel.

### BACKGROUND OF THE INVENTION

### 1. Field of the Invention

The present invention relates generally to a cable, and more particularly to a low-loss and high-speed signal cable used to transmit high-frequency signals.

### 2. Description of Related Arts

With the rapid development of big data and the Internet of Things, the demand for high-speed and high-frequency signal cables has grown rapidly. However, in the process of high-frequency and high-power signal transmission, cables are susceptible to interference from external electromagnetic signals and cannot guarantee stable and effective signal transmission.

Therefore, it is necessary to provide a high-speed signal cable with low loss, high transmission rate, good bending resistance, and simple manufacturing.

### SUMMARY OF THE INVENTION

A main object of the present invention is to provide a high-speed signal cable with low loss, high transmission rate, and good bending resistance.

To achieve the above-mentioned object, a cable comprises a pair of wires including two inner conductors and a respective insulating layer covering each of the two inner conductors; a first shielding layer covering the pair of core wires; a second shielding layer covering the first shielding layer; and an outer coating layer covering the second shielding layer, wherein the insulation layer is covered with a sheath layer that is simultaneously extruded and formed, and the sheath layer covers the core wires so that the two core wires abut each other in parallel.

Compared to prior art, the present invention has the advantage that the cable conductor spacing is smaller, making the structure more compact. At the same time, the cable has good shielding effect and good bending resistance.

### BRIEF DESCRIPTION OF THE DRAWING

FIG. 1 is a cross-sectional view of a first embodiment of a cable of the present invention;

FIG. 2 is a cross-sectional view of a second embodiment of the cable of the present invention;

FIG. 3 is a cross-sectional view of a third embodiment of the cable of the present invention;

FIG. 4 is a cross-sectional view of a fourth embodiment of the cable of the present invention;

FIG. 5 is a cross-sectional view of a fifth embodiment of the cable of the present invention;

FIG. 6 is a cross-sectional view of a sixth embodiment of the cable of the present invention;

FIG. 7 is a cross-sectional view of a seventh embodiment of the cable of the present invention; and

FIG. 8 is a cross-sectional view of an eighth embodiment of the cable of the present invention.

### DETAILED DESCRIPTION OF THE PREFERRED EMBODIMENTS

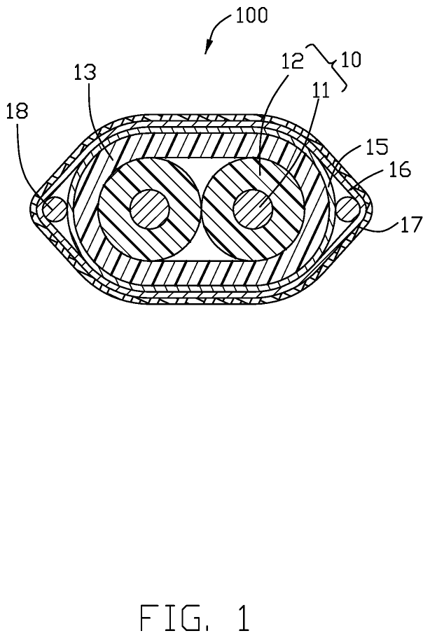

FIG. 1 shows the first embodiment of a cable 100 of the present invention. The cable 100 includes a core wire 10, a first shielding layer 15 covering the core wire 10, and a second shielding layer 16 covering the first shielding layer 15. Two ground wires 18 are arranged between the first shielding layer 15 and the second shielding layer 16 and an outer coating layer 17 covering the second shielding layer 16.

In this embodiment, the core wire 10 includes two wires abutting each other in parallel and extending in the longitudinal direction. The core wire 10 includes two inner conductors 11, and the two inner conductors 11 are separately covered with an insulating layer 12, the insulating layer 12 is covered with a sheath layer 13 which is simultaneously extruded and formed. The sheath layer 13 compactly wraps the core wire 10, so that the two core wires abut in parallel, which can effectively reduce the attenuation in the signal transmission process, and at the same time, further enhance the anti-twisting performance, greatly reducing and dispersing the torsion stress on the core wire, and prolongs the service life of the cable. It should be noted that there are air gaps between the insulating layer 12 and the sheath layer 13, and there are also air gaps between the first shielding layer 15, the ground wire 18 and the second shielding layer 16.

The inner conductor 11 is selected from the group including a pure copper conductor, a silver-plated copper conductor, and a tin-plated copper conductor. The insulating layer 12 is made of any one or a mixture of two of polyethylene, polypropylene, polyperfluoroethylene propylene, foamed polyethylene, Foamed polyperfluoroethylene propylene, and polytetrafluoroethylene. The sheath layer 13 is made of any one or a mixture of two of polyethylene, polypropylene, polyperfluoroethylene propylene, foamed polyethylene, Foamed polyperfluoroethylene propylene, and polytetrafluoroethylene.

The first shielding layer 15 is spirally wound or longitudinally wraps the core wire 10. The coating method of transverse winding will have seams between adjacent windings, so compared to the coating method of transverse winding, the shielding effect of spiral winding or longitudinal coating is better. The first shielding layer 15 is selected from the group including hot-bonded aluminum foil, pure aluminum foil, double-sided aluminum foil, heat-bonded copper foil, pure copper foil, and double-sided copper foil. The second shielding layer 16 is spirally wound or longitudinally wraps the first shielding layer 15. The second shielding layer 16 is selected from the group including hot-bonded aluminum foil, pure aluminum foil, double-sided aluminum foil, heat-bonded copper foil, pure copper foil, and double-sided copper foil. The second shielding layer 16 increases the thickness of the entire shielding layer and increases the shielding effect. At the same time, the two-layer shielding layer also enhances the bending resistance of the cable.

The outer coating layer 17 is made of hot-bonded PET (polyethylene terephthalate), which is spirally wound in different directions to cover the second shielding layer 16 to make the cable structure more stable. The ground wire 18 is arranged at the left and right ends of the outer side of the first shielding layer 15, and is located on the extension line of the center line of the inner conductor 11.

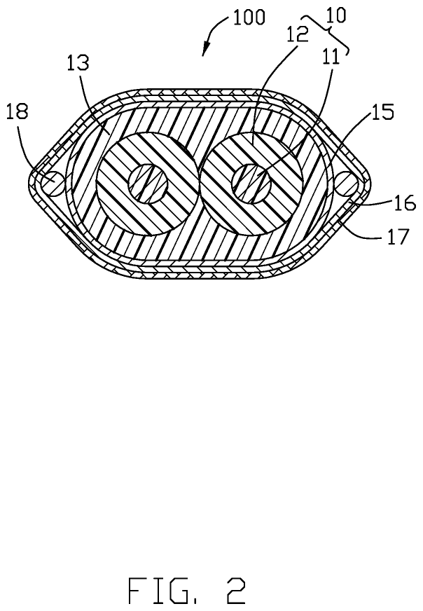

FIG. 2 shows the second embodiment of the cable of the present invention. Compared with the first embodiment, there is no air gap between the sheath layer 13 and the insulating layer 12 in this embodiment, and the others remain unchanged.

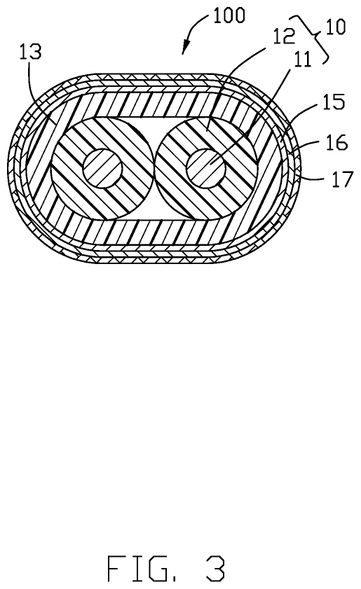

FIG. 3 shows the third embodiment of the cable of the present invention. Compared with the first embodiment, the ground wire 18 is not provided in this embodiment, and the others remain unchanged.

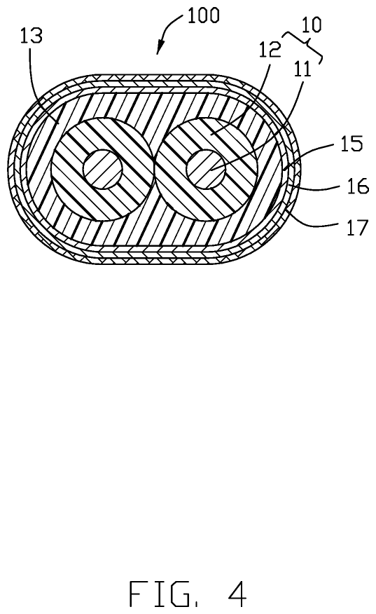

FIG. 4 shows the fourth embodiment of the cable of the present invention. Compared with the second embodiment, the ground wire 18 is not provided in this embodiment, and the others remain unchanged.

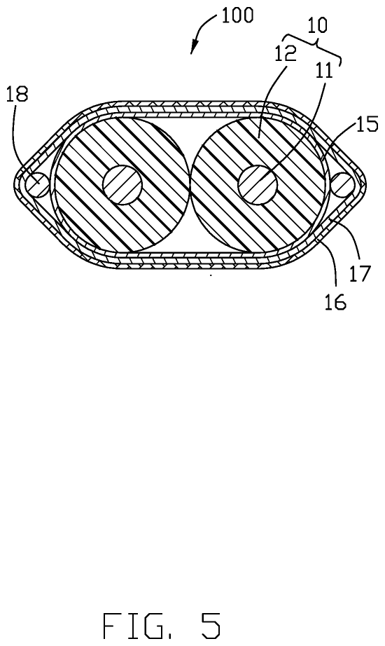

FIG. 5 shows the fifth embodiment of the cable of the present invention. Compared with the first embodiment, the insulating layer 12 of the core wire 10 is directly covered by the first shielding layer 15, and there is no sheath layer 13 between the insulating layer 12 and the first shielding layer 15 in this embodiment, and the others remain unchanged.

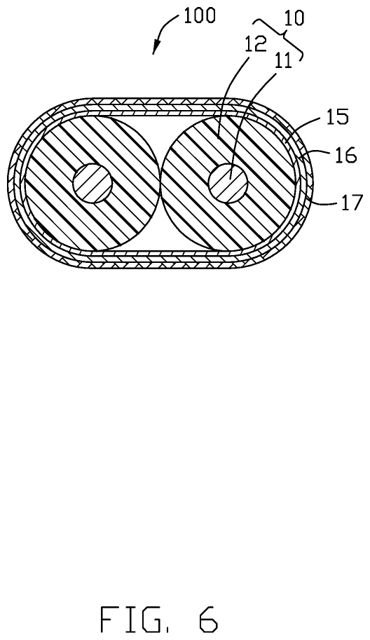

FIG. 6 shows the sixth embodiment of the cable of the present invention. Compared with the fifth embodiment, the ground wire 18 is not provided in this embodiment, and the others remain unchanged.

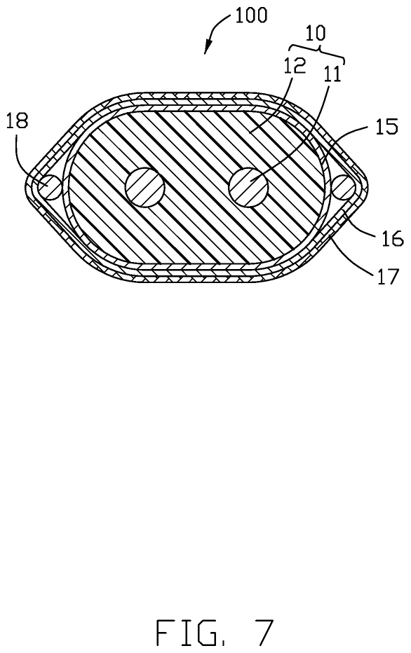

FIG. 7 shows the seventh embodiment of the cable of the present invention. Compared with the fifth embodiment, the insulating layer 12 is integrally formed and extruded on the two inner conductors 11, and the others remain unchanged.

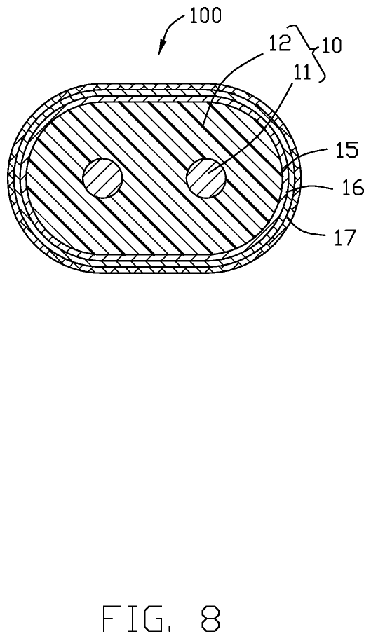

FIG. 8 shows the eighth embodiment of the cable of the present invention. Compared with the seventh embodiment, the ground wire 18 is not provided in this embodiment, and the others remain unchanged.

The above describes only some of the embodiments of the present invention, but not all of the embodiments. Any equivalent changes to the technical solutions of the present invention by those skilled in the art by reading the description of the present invention are covered by the claims of the present invention.

What is claimed is:

1. A cable comprising:
a pair of wires including two inner conductors and a respective insulating layer covering each of the two inner conductors;
a first shielding layer covering the pair of wires;
a second shielding layer covering the first shielding layer; and
an outer coating layer covering the second shielding layer; wherein
the insulation layer is covered with a sheath layer that is simultaneously extruded and formed, and the sheath layer covers the wires so that the two wires abut each other in parallel.

2. The cable as claimed in claim 1, wherein the first shielding layer is spirally wound or longitudinally wraps the wires, the first shielding layer is selected from the group consisting of hot-bonded aluminum foil, pure aluminum foil, double-sided aluminum foil, hot-bonded copper foil, pure copper foil, and double-sided copper foil.

3. The cable as claimed in claim 1, wherein the second shielding layer is spirally wound or longitudinally wraps the first shielding layer, the second shielding layer is selected from the group consisting of hot-bonded aluminum foil, pure aluminum foil, double-sided aluminum foil, hot-bonded copper foil, pure copper foil, and double-sided copper foil.

4. The cable as claimed in claim 1, further comprising two ground wires arranged between the first shielding layer and the second shielding layer.

5. The cable as claimed in claim 4, wherein the ground wire is selected from the group including a pure copper conductor, a silver-plated copper conductor, and a tin-plated copper conductor.

6. The cable as claimed in claim 4, wherein the ground wire is arranged at two outer ends of the first shielding layer, and is located on an extension line of the center line of the inner conductor.

7. The cable as claimed in claim 1, wherein the insulating layer is made of a material selected from the group consisting of polyethylene, polypropylene, polyperfluoroethylene propylene, foamed polyethylene, Foamed polyperfluoroethylene propylene, and polytetrafluoroethylene.

8. The cable as claimed in claim 1, wherein the sheath layer is made of a material selected from the group consisting of polyethylene, polypropylene, polyperfluoroethylene propylene, foamed polyethylene, foamed polyperfluoroethylene propylene, and polytetrafluoroethylene.

9. The cable as claimed in claim 1, wherein the inner conductor is selected from the group consisting of a pure copper conductor, a silver-plated copper conductor, and a tin-plated copper conductor.

10. The cable as claimed in claim 1, where the outer coating layer is hot-bonded PET and is spirally wound to cover the second shielding layer.
